(19) United States
(12) Patent Application Publication
(10) Pub. No.: US 2004/0032315 A1
(43) Pub. Date: Feb. 19, 2004

(54) Variable inductor responsive to AC current level

(76) Inventor: Lewis Illingworth, Kensington, NH (US)

Correspondence Address: Ward & Olivo, Suite 300, 382 Springfield Avenue, Summit, NJ, 07901, US

(21) Appl. No.: 10/223,710

(22) Filed: Aug. 19, 2002

(51) Int. Cl. H01F 27/24

(52) U.S. Cl. 336/212

(57) ABSTRACT

Disclosed herein is a variable inductor whose inductance automatically varies directly with current. The variable inductor has a low inductance during a low current condition and a high inductance during a current overload condition. In the preferred embodiment, iron cores slide in and out of inductor coils based upon the magnetic attraction generated by applying current to the coils. In alternate embodiments, the present invention uses inductor coils encircling cores comprising sections of readily saturable magnetic materials and sections of materials capable of withstanding a high magnetic flux density. In a low current condition, the coils have an inductance equal to air core inductors, while in an overload condition, they have an inductance equal to iron-core inductors.

### FIELD OF THE INVENTION

The present invention relates to a variable inductor whose inductance varies with current. Such inductors find use in the field of current limiting devices. More particularly, the preferred embodiment of the present invention relates to an AC current limiting inductor in which the inductance increases as the applied current increases.

### BACKGROUND OF THE INVENTION

Existing current limiting devices such as fuses and circuit breakers need to be replaced or reset, respectively, after an overload. However, the variable inductor of the present invention does not need to be replaced or reset. Therefore, the present invention can replace fuses or circuit breakers to protect electrical devices from an overload condition.

Existing loudspeaker protection circuitry also employs circuit breakers or fuses. However, such devices respond only to input power, without regard to which frequency components are most prominent. Thus, when the protection circuitry is triggered, the entire loudspeaker is turned off. Loudspeaker damage is most commonly due to voice coil burnout and not mechanical over-excursion. Thus, it would be preferable to provide a loudspeaker protection device that can protect loudspeakers from an overload of high frequency content without completely shutting off the loudspeaker.

The use of current limiters to protect a load from overload conditions is already known in the art. Furthermore, variable inductors, which can be used as current limiters, are also known in the art. However, current limiting variable inductors as described and claimed herein are not found in the art. In fact, the art yields surprisingly little evidence of inductors that automatically vary inductance in response to real time current conditions.

So-called “Swinging Chokes” have been used for many years in rectifier circuits. Such devices have a high inductance value at low current levels, while the inductance value automatically falls as the current increases. This effect is achieved by allowing the choke (inductor) core to progressively saturate with increasing current. Unfortunately, this is exactly the reverse of what is required in a current limiting inductor for which the inductance must be low at low current levels and high at high current levels.

The following references, which are discussed below, were found to relate to the field of variable inductors: Thornton et al., U.S. Pat. No. 4,441,092 (“Thornton”); Atherton, U.S. Pat. No. 4,529,956 (“Atherton”); Jackson et al., U.S. Pat. No. 4,695,917 (“Jackson”); Takada, U.S. Pat. No. 4,725,805 (“Takada”); Barbier et al., U.S. Pat. No. 4,736,513 (“Barbier”); Mouri et al., U.S. Pat. No. 4,987,930 (“Mouri”); Biegel, U.S. Pat. No. 5,347,257 (“Biegel”); Goldberg et al., U.S. Pat. No. 5,450,052 (“Goldberg”); Ratliff et al., U.S. Pat. No. 5,754,034 (“Ratliff”); Hammond et al., U.S. Pat. No. 5,999,077 (“Hammond”); Swope et al., U.S. Pat. No. 6,275,131 B1 (“Swope”); and Jansen, U.S. Pat. No. 6,317,021 B1 (“Jansen”).

Thornton discloses a rotatable inductor coil to which a conducting contactor wheel is applied. A magnetic inductor core mechanically attached to the contactor wheel is located inside the rotatable inductor coil. Upon rotation of the inductor coil, the contactor wheel travels along the wire comprising the inductor coil. Thus, the wheel travels axially in relation to the coil. Because the magnetic inductor core is attached to the contactor wheel, it also travels axially with respect to the inductor coil. Thus, by altering the point of electrical connection between the contactor wheel and the inductor coil as well as moving the magnetic inductor core, the inductance is varied. However, it would be preferably to automatically adjust inductance to limit current in an overload condition or reset itself thereafter.

Atherton discloses a pot-core transformer with an adjustable magnetic shunt to add the function of a variable series inductor independent of the transformer. Specifically, a metallic wedge can be mechanically adjusted within the core of the inductor in order to occupy either more or less of an air gap. The replacement of air with a magnetic material causes the inductance to change. Like Thornton, in order to vary the inductance, the Atherton device must be manually adjusted. It would be preferable to provide a device capable of performing automatic reset and/or adjustment of inductance.

Jackson discloses a circuit design utilizing inductors in conjunction with solid state switches to create a variable inductor circuit. In one condition, the current flowing through the separate inductor coils is such that the magnetic fields they produce cancel each other out, providing a low inductance. In the second condition, the inductor's coils are configured such that the magnetic fields are neutral to or reinforce each other, thereby providing a high inductance. Solid state switching technology is used in order to either bypass or include various inductor coils such that any one of the aforementioned conditions appropriately occur. Jackson employs multiple inductor coils along with solid state switching technology in order to produce the desired effect. Furthermore, Jackson's device requires an external switching means to activate the solid state switch to change the inductance. It would be beneficial to the art to provide a device capable of performing automatic adjustment of inductance and/or reset as performed by the present invention.

Takada discloses a variable inductor in which the core is attached to a threaded member. Via rotation of the threaded member, the inductor core is moved axially in respect to the inductor coil such that the inductance is varied. Nevertheless, the core must be externally controlled in order to vary the inductance. It is preferable to automatically adjust to an overload condition and/or automatically reset after such condition.

Barbier discloses a variable inductor similar to that of Takada in which the magnetic core is adjustable via a threaded member. As with Takada, Barbier fails to disclose a device that can automatically function as a current limiter in an overload condition and automatically reset.

Mouri discloses a variable inductor utilizing a core constructed of a Type II superconductor having a reversible magnetic permeability variation range. Herein, the permeability of the superconductor core can be controlled via an externally supplied magnetic field variation or current variation. As the permeability of the superconductor core varies, the inductance of the inductor also varies. The present invention, however, does not require a superconductor core or variation of its permeability as Mouri does. Moreover, the permeability of the core in Mouri must be externally controlled in order to appropriately vary inductance.

Biegel discloses an inductor which comprises a movable magnetic core within an inductor coil. A control device is attached to the movable portion of the magnetic core such that the configuration of the gap within the space surrounded by the coil can be appropriately altered to effect varying inductances. It would be preferable to provide a device that can automatically vary inductance based upon a change in applied current.

Goldberg discloses a variable inductor which controls the inductance of a linear conductor with a magnetic field resulting from a variable current through a coaxial solenoid with a magnetic core. Therefore, this device requires both a solenoid and a linear conductor. Also, according to Goldberg the inductance must be externally controlled by varying the current through the solenoid. It would be preferable, however, to automatically adjust to accommodate overload conditions.

Ratliff discloses a variable inductor comprised of two magnetic cores with coils wound around them. A DC bias coil is wound around one of the aforementioned magnetic cores as well. When DC current is applied to the DC bias coil, magnetic flux is created in the inductor core which appropriately varies inductance. Yet, as in the other references discussed herein, Ratliff requires external control and an external control circuit in order to vary inductance. It would be preferable to automatically adjust to fluctuations in current input.

Hammond discloses a variable inductor in which two control cores mechanically adjust their distance to winding cores. Adjustment of the control cores is governed by actuators which respond to a control voltage. Variation of the gap between the control cores and the winding cores effects variation in the inductance of the inductor. A device according to Hammond is not capable of automatically varying inductance in response to changes in applied current.

Swope discloses a variable inductor in which the shape of the inductor coil varies in accordance with its thermal condition. In order to achieve this, Swope uses a coiled elastic support member constructed with a mechanical memory. The coiled elastic support member is designed such that application or removal of heat energy changes the shape of the coil. A conductive layer is wrapped around the coiled elastic support member such that it can conduct electricity as an inductor. A final insulating layer is provided around the conductive layer to provide electrical insulation. Externally applied heat or internally created heat is used to control the shape of the coil, thereby varying inductance. It would be preferable to provide a device that does not require an external source of heat and does not rely on changes in temperature.

Finally, Jansen discloses an inductor having a core with three legs, two outer legs and one center leg. The two windings of the inductor are located on the outer legs. A control winding is located on the center leg. Application of a current to the control winding alters the magnetic flux in the core. Altering the flux in the core, in turn, alters the inductance of the outer windings. Like much of the art already discussed, Jansen requires external current to control the inductance of the core. It would be preferable to automatically adjust inductance in response to input current.

The art is completely devoid of a simple variable inductor that can act as an automatic current limiter without external control. There is a clear need for a variable inductor that can act as a current limiter in an overload condition without requiring external control and with the ability to automatically reset when the overload condition is removed.

### SUMMARY OF THE INVENTION

The present invention relates to a novel inductor that automatically adjusts inductance in response to changes in input current. The present invention is a simple device that can automatically protect a load in an overload condition and automatically resets after normal operation resumes.

Further, unlike other current limiting devices, the present invention is capable of protecting a load without additional control circuitry or external control mechanisms. Disclosed herein is a device that is both simpler and more efficient than other current limiting devices.

Rather than relying on external control, the inductors of the present invention automatically adjust to various current conditions. An embodiment of the present invention comprises one rectangular, closed loop core and two coils. The rectangular core is comprised of two iron sections and two ferrite sections. Two coils are formed by wires wound around each of the iron sections such that the magnetic flux paths from each coil have equal and opposite components when a low current is applied to the windings. The opposing magnetic flux paths cancel the coupling of the windings to the iron cores causing the two coils to act as two air core coils connected in series with a low overall inductance. When the current through the coils is increased to a critical level, the ferrite sections become saturated and the magnetic circuit coupling the two iron cores collapses. The coils then act as two separate iron core inductors connected in series with a high overall inductance. When the current is returned to a lower level, the ferrite cores return to an unsaturated state, the magnetic circuit coupling the iron cores is restored, the magnetic flux paths cancel, and the coupling of the windings to the iron cores cancel each other out resulting in a low overall inductance.

An alternate embodiment of the present invention is designed to achieve an even greater change in inductance in response to an overload condition. This embodiment comprises two rectangular, closed loop cores, each core comprised of one U-shaped ferrite section and one I-shaped iron section. The cores are arranged in a row such that the I-shaped iron section of the first core is located at the bottom and the I-shaped iron section of the second core is located at the top. Like the embodiment discussed above, two coils are formed by wires wound around the top sections of the cores and the bottom sections of the cores. At low current conditions, the opposing magnetic flux paths cancel the coupling of the windings to the iron and ferrite cores causing the coils to act as two air core inductors connected in series having a low overall inductance. As the current applied to the windings increases, the ferrite cores saturate causing the magnetic circuit to collapse. Thus, the coils act as two separate iron core inductors wired in series having a high overall inductance.

In the preferred embodiment of a current limiting device according to the present invention, a mechanical mechanism is employed to vary the inductance in response to an overload condition. Specifically, this embodiment comprises two inductor coils, two U-shaped cores, and a spring-loaded frame on which the cores are situated. When a low current is applied to the inductor coils, the cores remain only partially inside the inductor coils. The overall inductance of the device at the low current level is that of two coreless or air core inductors wired in series. However, as the current within the device increases, the magnetic flux generated within the cores causes the cores to be attracted to each other. As the magnetic flux increases, the attractive force overcomes the opposing force imparted by the springs on the spring-loaded frame. Under this circumstance, the U-shaped cores move toward one another in such a way that their legs become substantially contained within the inductor coils.

As a result, the coils no longer have the inductance of air core inductors wired in series. Rather, they have the much larger inductance of two iron core inductors wired in series. As the current through the coils is decreased, the magnetic attraction of the iron cores decreases. Eventually, the force imparted by the springs overcomes the magnetic attraction of the iron cores, and returns the cores to their original position. The inductance of the device then returns to that of two air core inductors wired in series with a low overall inductance.

In sum, under low current conditions this embodiment for a current limiting device acts as two air core inductors wired in series with a low overall inductance. At higher current conditions, it acts as two iron core inductors wired in series with a high overall inductance. Thus, in a current overload, a high inductance is induced and the device acts as a current limiter. Moreover, the device returns to a low inductance automatically upon removal of the overload condition. Essentially, the device automatically resets itself for further operation under normal conditions. This is more advantageous than the use of fuses and circuit breakers, which must be replaced or manually reset, respectively.

Thus, it is an object of the present invention to provide a variable inductor that requires no external control mechanisms.

Also, it is an object of the present invention to provide an inductor in which the inductance automatically adjusts to various electrical current conditions.

Further, it is an object of the present invention to provide a variable inductor that acts as a current limiter.

It is yet another object of the present invention to provide a current limiter that automatically resets upon cessation of an overload condition.

It is still another object of the present invention to provide an inductor that acts as an air core inductor at low current levels.

It is another object of the present invention to provide an inductor that acts as an iron core inductor at high current levels.

It is yet another object of the present invention to provide an inductor that varies inductance via an automatic mechanical adjustment responsive to the instantaneous current condition.

It is another object of the present invention to provide a loudspeaker protection circuit.

### BRIEF DESCRIPTION OF THE DRAWINGS

FIG. 1A (PRIOR ART) depicts the integration of an inductor into circuitry as an AC current limiter under normal operation;

FIG. 1B (PRIOR ART) depicts the integration of an inductor as an AC current limiter in a maximum overload condition, i.e. the load is replaced with a short circuit;

FIG. 2 depicts an embodiment of a variable inductor according to the present invention comprising a rectangular, closed loop core comprised of two ferrite sections, two iron sections, and two coils;

FIG. 3 depicts an alternate embodiment of a variable inductor in accordance with the present invention comprising two rectangular, closed loop cores each comprised of one ferrite U-shaped section, one iron I-shaped section, and two coils; and

FIG. 4 depicts the preferred embodiment of a variable inductor in accordance with the present invention comprising two U-shaped cores, two coils, and a spring loaded frame.

FIG. 5 depicts an embodiment of a variable inductor in accordance with the present invention for use with three phase power comprising two W-shaped cores, three coils, and a spring loaded frame.

### DETAILED DESCRIPTION OF THE PREFERRED EMBODIMENTS

As required, a detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

Electrical circuits are generally protected from over-currents by fuses or circuit breakers. Following an over-current event, a blown fuse must be replaced or a circuit breaker manually reset. The present invention, on the other hand, can limit circuit current in an overload condition and also automatically resets when the overload condition is removed.

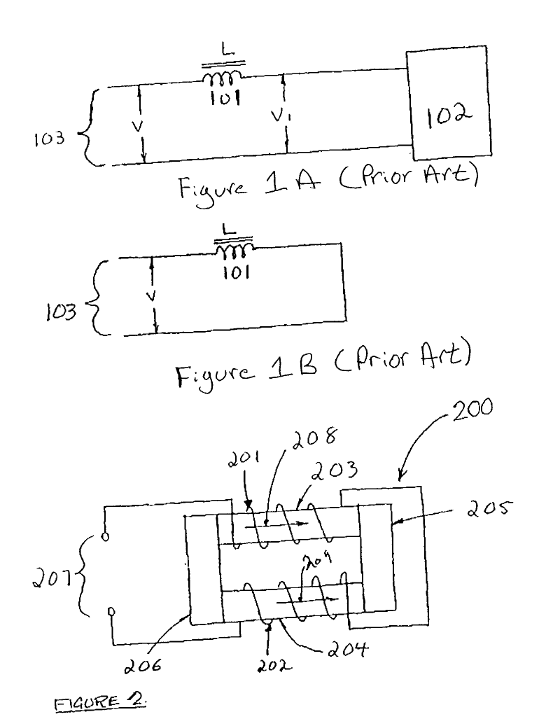

An inductor has an impedance defined by the relationship Z=2πfL where Z is the impedance, f is the frequency, and L is the inductance. Thus, the current into an inductor equals V/Z where V is the voltage across the inductor. FIGS. 1A and 1B show how an inductor 101 may be implemented as a current limiter in the circuitry with an AC input 103 into a load 102. In FIG. 1A, the AC input 103 is connected to a load 102 via an inductor 101. In FIG. 1B, the FIG. 1A load 102 is replaced by a short circuit, which is the current overload condition. Since the input current I is V/Z, to use an inductor 101 as a current limiter, the inductance has to be made large enough so that in a short circuit condition the maximum allowable current is defined by V/Z. In the normal operating condition, i.e. FIG. 1A, with the inductor 101 in series with the load 102, the voltage, V1, at the load 102 is less than the voltage at the AC input 103. The relationship is not the same as that for a resistor because the voltage across L is 90° out of phase with the current through it. Thus the voltage at the load cannot be determined as though the inductor and load were two resistances, but rather must be determined by a geometrical analysis that accounts for the phase shifts through the two impedances. Nevertheless, an inductance L that is large enough to limit the current to an acceptable value will result in the voltage V1 applied to load 102 being unacceptably low. In other words, the inclusion of an inductor 101 with an inductance L that has a sufficiently high value for current limiting action also leads to a lagging circuit power factor that may not be acceptable for normal load operation. Consequently, an inductor must at least meet two requirements to be used as a current limiter. First, the inductance L has to be sufficiently high to limit overload currents. Second the inductance L must be sufficiently small such that the voltage across the load is maintained close to that of the AC input voltage under normal operation. These two requirements are generally mutually exclusive. Therefore, the inductance, L, must vary appropriately in response to either normal operation or an overload condition. The present invention meets these two requirements with a novel design for a variable inductor.

An embodiment of variable inductor 200 according to the present invention is shown in FIG. 2. As shown, variable inductor 200 comprises a composite core having portions 205 and 206 made from readily saturable magnetic materials such as ferrite, and portions 203 and 204 made from materials that are capable of withstanding a high flux density such as grain oriented silicon steel. Core portions 203-206 are preferably arranged in a closed loop as shown such that the materials are alternating, and such that steel cores 203 and 204 are connected at their ends by two ferrite cores 205 and 206. Two coils or windings 201 and 202 encircle (or are wound around) steel cores 203 and 204. Windings 201 and 202 are such that the magnetic flux paths 208 and 209 have equal and opposite components when a low current is applied to windings 201 and 202. The opposing magnetic flux paths 208 and 209 generated by application of the AC current cancel the coupling of windings 201 and 202 to steel cores 203 and 204, respectively, causing the overall inductance of windings 201 and 202 to be approximately equal to that of two air core coils wired in series (which is quite low in value).

While the two magnetic flux paths in ferrite cores 205 and 206 cancel each other, they do nevertheless co-exist. When the magnetic flux levels in steel cores 203 and 204 reach a critical level, the easily saturated ferrite cores 205 and 206 begin to saturate at their ends adjacent to the steel cores 203 and 204. When saturated, the magnetic circuit which couples cores 203 and 204 collapses. Coils 201 and 202 now have an inductance equal to two separate steel core inductors wired in series. Thus, in the high current condition, the total inductance of coils 201 and 202 is that of two separate steel core inductors wired in series and is considerably greater than the total inductance at low currents when saturable ferrite cores 205 and 206 provide flux canceling links.

Using a device according to this embodiment, the inductance change is generally in a ratio of 2 to 1. That is, the maximum inductance is two times greater than the lowest inductance. This ratio may be improved using other, more complex configurations. For example, an alternate embodiment for a variable inductor 300 having separate rectangular cores, each core comprised of a U-shaped ferrite core and I-shaped iron core as shown in FIG. 3 may be used. In this arrangement, two separate flux paths 308 and 309 are generated when a current is applied to the windings 301 and 302. When the current in the inductor winding 301 causes the magnetic flux density to increase above the saturation level of the ferrite core 306, the ferrite core 306 saturates. Simultaneously, current flowing in inductor winding 302 causes ferrite core 305 to saturate. Thus, the ferrite sections 305 and 306 saturate, and inductors 301 and 302 have an inductance equal to two iron core inductors wired in series. This leads to a greater inductance with increasing current. The overall maximum inductance of this embodiment, as in that of the embodiment of FIG. 2, is limited because the ferrite does not completely saturate therefore allowing a minimal magnetic flux path to occur. This effect may be minimized by physically separating the rectangular core comprised of cores 303 and 305 from the rectangular core comprised of cores 304 and 306. This embodiment of the present invention is capable of creating a maximum inductance that is four times greater than the lowest inductance.

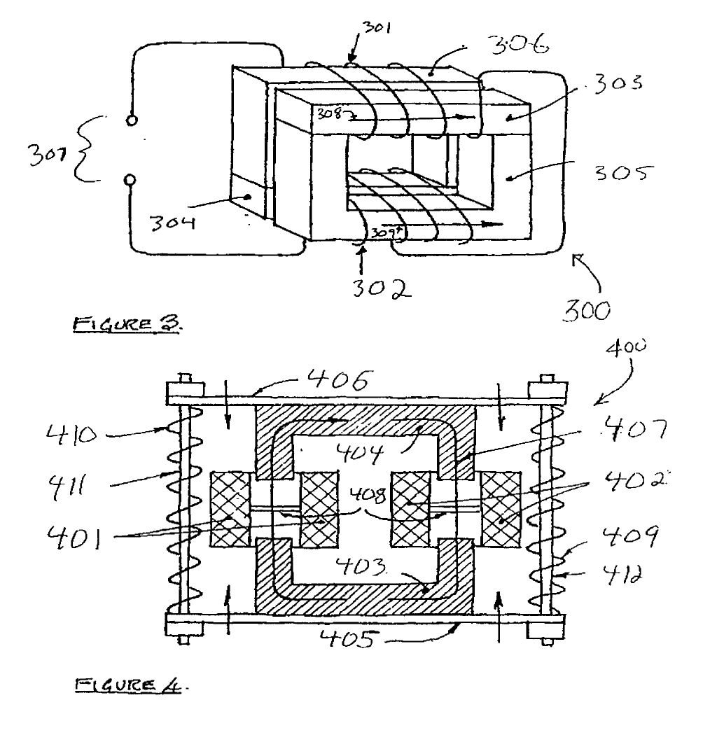

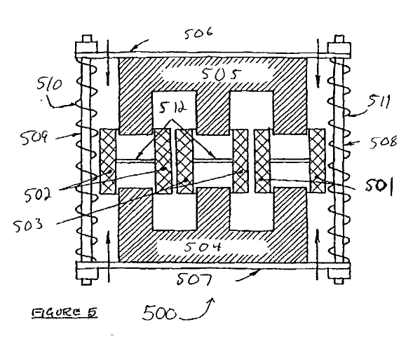

However, the current limiting requirements of certain applications have been experimentally determined to require a variable inductor which can increase inductance up to 10 or 20 times larger than the lowest inductance to achieve a full current to zero current swing. This range of inductance can be readily achieved with the preferred embodiment of a variable inductor according to the present invention, an arrangement that utilizes moving iron cores as depicted in FIG. 4.

FIG. 4 shows the preferred embodiment of variable inductor 400 comprising spring mounted U-shaped cores 403 and 404 mounted on plates 405 and 406, respectively. Plates 405 and 406 are attached at ends of guide rods 411 and 412 which have springs 410 and 409 positioned axially thereon to provide a resistance to compression of plates 405 and 406. Cores 403 and 404 are arranged such that their ends may laterally move into two inductor windings 401 and 402 during compression. In the normal, low current state cores 403 and 404 are positioned apart from each other but such that their ends partially penetrate the inductor windings 401 and 402, as shown. In this condition, the total inductance is that of two separate air core inductors. As the current applied to windings 401 and 402 increases, the magnetic flux 407 induced in U-shaped cores 403 and 404 causes them to be magnetically attracted to one another. As the magnetic attraction increases, the cores 403 and 404 begin to move toward one another while compressing springs 409 and 410 on either side. When the current reaches a critical value, the attraction between cores 403 and 404 completely overcomes the resistance of springs 410 and 409, and the cores 403 and 404 snap together. End stops 408 may be inserted to prevent the cores 403 and 404 from actually touching and also to control the maximum inductance. With the cores 403 and 404 held together by magnetic attraction, two iron core inductors are produced, having an inductance value 10 to 20 times greater than that of the lowest inductance value. Conversely, lowering the circuit current reduces the magnetic attraction between cores 403 and 404. Cores 403 and 404 then separate through the force of springs 410 and 409 and return to their original expanded position, and returning the variable inductor 400 once again to an inductance equal to that of two separate air core inductors wired in series. Thus, variable inductor 400 automatically resets itself to operate under normal current conditions.

This arrangement acts as an automatic current limiting device when used in the circuit of FIG. 1. Adjusting the tension of springs 409 and 410 adjusts the current level at which cores 403 and 404 will “snap” together and provide a high inductance to limit circuit current. Once the current overload is removed, the current decreases, the cores separate, and the inductance returns to a low value having a minimum effect on the voltage applied to the load 102.

The mechanical arrangement shown in FIG. 4 is just one of many configurations that may be employed in accordance with the present invention. For example, a wide variety of spring systems are possible. The configuration shown in FIG. 4 with core mounting plates 405 and 406 sliding on guide rods 411 and 412 with compression springs 409 and 410 is just one of many configurations. An alternate configuration may include a different quantity or location of springs 409 and 410. Additionally, mounting plates 405 and 406 may be arranged in a non-rectangular form. The inductor windings 401 and 402 are fixed and the connections to them do not have to be flexible. It is important that the two cores 403 and 404 be equally positioned with respect to the windings 401 and 402 when in the normal (low current) state, but they do not have to move evenly into the windings 401 and 402 providing that they eventually reach the end stops 408.

The circuit shown in FIG. 4 may serve as a current limiter for a single phase electrical circuit. This preferred embodiment may be expanded to for use in a three phase electrical circuit, as shown in FIG. 5, by employing conventional three phase transformer cores 504 and 505 and separate windings 501, 502 and 503 for each of the three phases. As in the preferred embodiment of FIG. 4, core mounting plates 506 and 507, guide rods 508 and 509, compression springs 510 and 511, and end stops 512 are provided. This embodiment functions essentially in the same fashion as the single phase inductor. Under a low current condition, the system acts as three separate air core inductors. As current increases, as in an overload condition, magnetic flux causes cores 504 and 505 to be magnetically attracted to each other. When the magnetic attraction overcomes the resisting force of the compression springs 510 and 511, the cores 504 and 505 pull together producing three iron core inductors, each with a higher inductance. Preferably, end stops 512 are once again provided to prevent the cores 504 and 505 from contacting one another. Once the current returns to a lower level, the system resets itself. Specifically, the magnetic attraction of the cores 504 and 505 diminish such that the springs 510 and 511 expand, thereby returning cores 504 and 505 to their original position. Again, the system acts as three air core inductors, each with a low inductance.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

I claim:

1. A variable inductor comprising:
a core;
a first winding encircling said core; and
a second winding encircling said core, wherein said first and second windings encircle said core such that the magnetic flux of said first and second windings cancels the magnetic coupling of said first and second windings to said core at low current levels; and said first and second windings encircle said core such that the magnetic flux of said first and second windings does not cancel the magnetic coupling of said first and second windings to said core at high current levels.

2. A variable inductor according to claim 1, wherein said core comprises at least two materials.

3. A variable inductor according to claim 1, wherein said core comprises a first material capable of withstanding a high flux density and a second material that is a readily saturable magnetic material.

4. A variable inductor according to claim 1, wherein said core comprises a first material capable of withstanding a high flux density and a second material that is a readily saturable magnetic material, wherein said first material comprises grain oriented silicon steel.

5. A variable inductor according to claim 1, wherein said core comprises a first material capable of withstanding a high flux density and a second material that is a readily saturable magnetic material, wherein said second material comprises ferrite.

6. A variable inductor according to claim 1, wherein at least one winding encircling a second core is connected in series with said first and second windings.

7. A variable inductor according to claim 1, wherein said variable inductor is utilized as a current limiter.

8. A variable inductor according to claim 1, wherein said variable inductor is utilized as a loudspeaker protector.

9. A variable inductor according to claim 1, said variable inductor further comprising at least two terminals for coupling said variable inductor to an external circuit.

10. A variable inductor comprising:
a core comprising at least four contiguous sections forming a closed loop, wherein a first pair of said sections are comprised of a first material capable of withstanding a high flux density and wherein a second pair of said sections are comprised of a second material that is a readily saturable magnetic material;
a first winding encircling one of said first pair of sections; and
a second winding encircling the other of said first pair of sections, wherein said first and second windings encircle said core such that the magnetic flux of said first and second windings cancels the magnetic coupling of said first and second windings to said core at low current levels and said first and second windings encircle said core such that the magnetic flux of said first and second windings does not cancel the magnetic coupling of said first and second windings to said core at high current levels.

11. A variable inductor according to claim 10 further comprising:
a conductor for coupling said first and second windings; and
at least two terminals for coupling said variable inductor to an external circuit.

12. A variable inductor according to claim 10, wherein said variable inductor is utilized as a current limiter.

13. A variable inductor according to claim 10, wherein said variable inductor is utilized as a loudspeaker protector.

14. A variable inductor according to claim 10, wherein said first material comprises iron.

15. A variable inductor according to claim 10, wherein said first material comprises grain oriented silicon steel.

16. A variable inductor according to claim 10, wherein said second material comprises ferrite.

17. A variable inductor according to claim 10, wherein at least one winding encircling a second core is connected in series with said first and second windings.

18. A method of providing a variable inductance in an electrical circuit, said method comprising the steps of:
providing the inductance of a plurality of air-core inductors to a current applied to said circuit when said current is below a saturation level; and
providing the inductance of a plurality of iron-core inductors to said current automatically when said current is above said saturation level.

19. A variable inductor comprising:
a plurality of cores;
a first winding encircling said plurality of cores; and
a second winding encircling said plurality of cores, wherein said first and second windings encircle said plurality of cores such that the magnetic flux of said first and second windings cancels the magnetic coupling of said first and second windings to said plurality of cores at low current levels; and said first and second windings encircle said plurality of cores such that the magnetic flux of said first and second windings does not cancel the magnetic coupling of said first and second windings to said plurality of cores at high current levels.

20. A variable inductor according to claim 19, wherein each of said plurality of cores comprises at least two materials.

21. A variable inductor according to claim 19, wherein each of said plurality of cores comprises at least two materials, wherein a first material is capable of withstanding a high flux density and a second material is a readily saturable magnetic material.

22. A variable inductor according to claim 19, wherein each of said plurality of cores comprises at least two materials, wherein a first material is capable of withstanding a high flux density and a second material is a readily saturable magnetic material, wherein said first material comprises grain oriented silicon steel.

23. A variable inductor according to claim 19, wherein each of said plurality of cores comprises at least two materials, wherein a first material is capable of withstanding a high flux density and a second material is a readily saturable magnetic material, wherein said second material comprises ferrite.

24. A variable inductor according to claim 19, wherein at least one winding encircling a second plurality of cores is connected in series with said first and second windings.

25. A variable inductor according to claim 19, said variable inductor further comprising a conductor for coupling said first and second windings.

26. A variable inductor according to claim 19, said variable inductor further comprising at least two terminals for coupling said variable inductor to an external circuit.

27. A variable inductor according to claim 19, wherein said variable inductor is utilized as a current limiter.

28. A variable inductor according to claim 19, wherein said variable inductor is utilized as a loudspeaker protector.

29. A variable inductor comprising:
a plurality of cores comprising at least two contiguous sections forming a closed loop, wherein a first section comprises a material capable of withstanding a high flux density and wherein a second section comprises a material that is a readily saturable magnetic material;
a first winding encircling said first section of a first core, said second section of a second core, and said continuously alternating sections of any subsequent cores; and
a second winding encircling said second section of a first core, said first section of a second core, and said continuously alternating sections of any subsequent cores, wherein said first and second windings encircle said plurality of cores such that the magnetic flux of said first and second windings cancels the magnetic coupling of said first and second windings to said plurality of cores at low current levels; and said first and second windings encircle said plurality of cores such that the magnetic flux of said first and second windings does not cancel the magnetic coupling of said first and second windings to said plurality of cores at high current levels.

30. A variable inductor according to claim 29, said variable inductor further comprising a conductor for coupling said first and second windings.

31. A variable inductor according to claim 29, said variable inductor further comprising at least two terminals for coupling said variable inductor to an external circuit.

32. A variable inductor according to claim 29, wherein said first section comprises iron.

33. A variable inductor according to claim 29, wherein said first section comprises grain oriented silicon steel.

34. A variable inductor according to claim 29, wherein said second section comprises ferrite.

35. A variable inductor according to claim 29, wherein at least one winding encircling a second plurality of cores is connected in series with said first and second windings.

36. A variable inductor according to claim 29, wherein said variable inductor is utilized as a current limiter.

37. A variable inductor according to claim 29, wherein said variable inductor is utilized as a loudspeaker protector.

38. A variable inductor comprising:
at least one core;
at least one spring; and
at least one winding, wherein the inductance of said winding varies based upon the position of said core.

39. A variable inductor according to claim 38, wherein the quantity of said cores is a multiple of two.

40. A variable inductor according to claim 38, wherein the quantity of said cores is a multiple of two, said cores are arranged in pairs, and said pairs are symmetrical.

41. A variable inductor according to claim 38, said variable inductor further comprising at least one core carrier.

42. A variable inductor according to claim 38, wherein said winding encircles primarily air when said spring is in a decompressed state; and said winding encircles portions of said core when said spring is in a compressed state.

43. A variable inductor according to claim 38 wherein said variable inductor is utilized as a current limiter.

44. A variable inductor according to claim 38 wherein said variable inductor is utilized as a loudspeaker protector.

45. A variable inductor comprising:
at least one pair of cores, wherein said pair of cores is symmetrical;
at least one core carrier;
at least one spring; and
at least one winding, wherein said winding encircles primarily air when said spring is in a decompressed state; and said winding encircles portions of said pair of cores when said spring is in a compressed state.

46. A variable inductor according to claim 45 further comprising:
at least two of said windings; and
at least one conductor for coupling said windings.

47. A variable inductor according to claim 45 further comprising:
at least two of said windings;
at least two terminals for coupling said variable inductor to an external electrical circuit; and
a plurality of conductors for coupling said windings to said terminals.

48. A variable inductor according to claim 45, said variable inductor further comprising at least one end stop.

49. A variable inductor according to claim 45, said variable inductor further comprising at least one end stop to prevent each of said pair of cores from physically touching.

50. A variable inductor according to claim 45, said variable inductor further comprising at least one end stop for controlling the inductance of said variable inductor.

51. A variable inductor according to claim 45, wherein said spring has an adjustable tension such that adjusting said tension varies the current level at which said pairs of cores snap together.

52. A variable inductor according to claim 45, wherein said spring has an adjustable tension such that adjusting said tension varies the current level at which said variable inductor provides a maximum inductance.

53. A variable inductor according to claim 45, said variable inductor further comprising at least one guide rod wherein said guide rod is internal to said spring.

54. A variable inductor according to claim 45, wherein said pair of cores comprises a material capable of withstanding a high flux density.

55. A variable inductor according to claim 45, wherein the quantity of windings equals two and said cores are U-shaped such that each leg of said core passes into one of said two windings.

56. A variable inductor according to claim 45, wherein said decompressed spring separates said pair of cores such that a small portion of said cores is within said winding when a low current is applied to said variable inductor.

57. A variable inductor according to claim 45, wherein said winding has the inductance of an air core winding when a low current is applied to said variable inductor.

58. A variable inductor according to claim 45, wherein said current applied to said winding induces a magnetic flux in said pair of cores causing said pair of cores to move closer together and oppose the force of said spring.

59. A variable inductor according to claim 45, wherein applying a current to said winding induces a magnetic flux in said pair of cores causing said pair of cores to move closer together and oppose the force of said spring; and wherein an increasing in said current causes said pair of cores to snap together by overcoming the force of said spring.

60. A variable inductor according to claim 45, wherein said variable inductor is utilized as a current limiter.

61. A variable inductor according to claim 45, wherein said variable inductor is utilized as a loudspeaker protector.

62. A method of providing a variable inductance in an electrical circuit, said method comprising the steps of:
providing the inductance of a plurality of air core inductors to a current applied to said circuit; and
increasing said inductance to said current applied to said circuit automatically as said current is increased, wherein the maximum inductance is the inductance of a plurality of iron core inductors.

63. A method of providing a variable inductance according to claim 62, said method further comprising:
snapping at least one pair of cores together when said current is increased to a level that causes the magnetic attraction between said pair of cores to exceed the force of said spring holding said pair of cores apart.

64. A method of providing a variable inductance according to claim 62, said method further comprising:
snapping at least one pair of cores together when said current is increased to a level that causes the magnetic attraction between said pair of cores to exceed the force of said spring holding said pair of cores apart; and
adjusting the tension of said spring to vary said current level at which said pair of cores snap together.

65. A method of providing a variable inductance according to claim 62, further comprising the step of:
limiting current to a load.

66. A method of providing a variable inductance according to claim 62, further comprising the step of:
protecting a loudspeaker from excessive mid-frequency energy.

67. A method of providing a variable inductance according to claim 62, further comprising the step of:
protecting a loudspeaker from excessive high-frequency energy.

68. A variable inductor comprising:
at least one core;
at least one spring; and
at least three windings, wherein the inductance of said windings varies based upon the position of said core.

69. A variable inductor according to claim 68, wherein said quantity of cores is a multiple of two.

70. A variable inductor according to claim 68, wherein said quantity of cores is a multiple of two, said cores are arranged in pairs, and each of said pair of cores is symmetrical.

71. A variable inductor according to claim 68, said variable inductor further comprising at least one core carrier.

72. A variable inductor according to claim 68, wherein said windings encircle air when said spring is in a decompressed state and said windings encircle portions of said core when said spring is in a compressed state.

73. A variable inductor according to claim 68, wherein said variable inductor is utilized as a current limiter.

74. A variable inductor according to claim 68, wherein said variable inductor is utilized as a loudspeaker protector.

75. A variable inductor comprising:
at least one pair of cores, wherein said pair of cores is symmetrical;
at least one core carrier;
at least one spring; and
at least three windings, wherein the quantity of said windings is a multiple of three and said windings encircle primarily air when said spring is in a decompressed state; and said windings encircle portions of said pair of cores when said spring is in a compressed state.

76. A variable inductor according to claim 75, said variable inductor further comprising at least six terminals for coupling said variable inductor to an external three-phase electrical circuit.

77. A variable inductor according to claim 75, said variable inductor further comprising at least one end stop.

78. A variable inductor according to claim 75, said variable inductor further comprising at least one end stop for preventing said pair of cores from touching.

79. A variable inductor according to claim 75, said variable inductor further comprising at least one end stop for controlling the maximum inductance of said variable inductor.

80. A variable inductor according to claim 75, wherein adjusting the tension of said spring varies the current level at which said spring fully compresses.

81. A variable inductor according to claim 75, wherein adjusting the tension of said spring varies the current level at which said variable inductor provides a maximum inductance to an electrical circuit.

82. A variable inductor according to claim 75, said variable inductor further comprising at least one guide rod, wherein said guide rod is internal to said spring.

83. A variable inductor according to claim 75, wherein said cores comprise a material capable of withstanding a high flux density.

84. A variable inductor according to claim 75, wherein the quantity of said windings is three and said core is W-shaped such that each leg of said core passes into one of said three windings.

85. A variable inductor according to claim 75, wherein said spring is decompressed such that a small portion of said pair of cores is within said windings when a low current is applied to said variable inductor.

86. A variable inductor according to claim 75, wherein said windings have the inductance of three air core windings when a low current is applied to said variable inductor.

87. A variable inductor according to claim 75, wherein said current applied to said windings induces a magnetic flux in said pair of cores causing said pair of cores to move closer together opposing the force of said spring.

88. A variable inductor according to claim 75, wherein applying a current to said windings induces a magnetic flux which causes said pair of cores to move closer together; and wherein a increasing said current causes said pair of cores to snap together.
